(19) United States
(12) Patent Application Publication
(10) Pub. No.: US 2001/0043820 A1
(43) Pub. Date: Nov. 22, 2001

(54) Image forming apparatus and process cartridge detachably attachable thereto

(76) Inventors: Shuichi Kadota, Numazu-shi (JP); Fumiteru Gomi, Shizuoka-ken (JP); Kouichi Hashimoto, Numazu-shi (JP); Yoshiyuki Komiya, Mishima-shi (JP); Kenichi Shibuya, Shizuoka-ken (JP)

Correspondence Address: FITZPATRICK CELLA HARPER & SCINTO, 30 ROCKEFELLER PLAZA, NEW YORK, NY, 10112, US

(21) Appl. No.: 09/824,020

(22) Filed: Apr. 3, 2001

(30) Foreign Application Priority Data
Apr. 6, 2000 (JP) 2000-104597

(51) Int. Cl. G03G 15/02

(52) U.S. Cl. 399/175

(57) ABSTRACT

The present invention provides an image forming apparatus comprising a shiftable image bearing member, and an electrifying device adapted to electrify the image bearing member and having magnetic particles contacted with the image bearing member and a magnetic particle carrying device for magnetically holding and carrying the magnetic particles, and wherein a peak position of magnetic flux density of the magnetic particle carrying device near the image bearing member is located at a downstream side of a most approaching position between the magnetic particle carrying device and the image bearing member in a shifting direction of the image bearing member.

### BACKGROUND OF THE INVENTION

1. Filed of the Invention

The present invention relates to an image forming apparatus such as a copying machine, a printer and the like, and a process cartridge detachably attachable thereto, and more particularly, it relates to an image forming apparatus and a process cartridge having a electrifying apparatus for electrification by using magnetic particles.

2. Related Background Art

In recent years, although image forming apparatuses such as electrophotographic apparatuses in which an electrostatic latent image corresponding to an image to be recorded and formed on a photosensitive drum as an image bearing member is developed with developer (toner) as a toner image which is in turn recorded on a paper have been made compact more and more, there was limitation in compactness so long as each of image forming processes such as electrifying, exposing, developing, transferring, fixing and cleaning processes is made compact.

Further, although transfer-residual toner was collected as waste toner by a cleaner, it is preferable that such waste toner is eliminated in the viewpoint of protection of environment. To this end, an image forming apparatus of cleaner-less type in which the cleaner is omitted and cleaning simultaneous with developing is effected by a developing apparatus has been proposed.

The cleaning simultaneous with developing is a method in which residual toner remaining on an image bearing member after the transferring is collected by fog removing bias in a subsequent developing process. According to this method, since the transfer-residual toner is collected and is used in the subsequent processes, the waste toner can be eliminated and maintenance can be facilitated. Further, the space can be saved, thereby making the image forming apparatus compact greatly.

Further, as electrifying means for uniformly charging a member to be charged, a so-called electrifying device of contact electrifying type which can take advantage of low ozone and low power consumption, i.e., an electrifying device in which a member to be charged is charged by an electrifying member contacted with the member to be charged while applying voltage to the electrifying member has been put to practical use.

As such electrifying devices of contact type, an electrifying device of magnet brush type is preferably used in the viewpoint of stable contact electrification.

In the electrifying device of magnet brush type, conductive magnetic particles are magnetically held as a magnet brush directly on a magnet or a sleeve including a magnet therein, and the magnet or the sleeve as the electrifying member of contact type is contacted with the member to be charged while rotating or stopping the electrifying member, and electrification is started by applying voltage to the electrifying member.

Particularly, when the electrifying device of magnet brush type is used and a photosensitive member having a surface layer in which conductive fine particles are dispersed in normal organic photosensitive body or an amorphous silicone photosensitive member is used as an image bearing member to be charged, electrification potential substantially equal to DC component of bias applied to the magnet brush as the contact electrifying member can be obtained on the surface of the image bearing member. Such an electrifying method is called as injecting electrification. By using such injecting electrification, since the electrification of the member to be charged does not utilize a discharging phenomenon, unlike to electrification effected by using a corona charger, ozone is not generated and low power consumption can be achieved. Thus, such injecting electrification has been noticed.

However, in the above-mentioned injecting electrification, the magnetic particles constituting the magnet brush as the contact electrifying member may be separated (or desorbed) from the magnet brush and be adhered to the member to be charged (referred to as “carrier adhesion” hereinafter). The carrier adhesion occurs noticeably at an electrifying nip portion as a contact area between the member to be charged and the magnet brush, and, particularly, at a downstream end of the nip portion in a rotational direction of the member to be charged. The reason is that a magnetic holding force of the magnetic particle carrying member for holding the magnetic particles is insufficient at that portion.

If the carrier adhesion occurs, the following disadvantages are generated in the image forming apparatus.

(1) Poor electrification and poor collection of residual toner, since a contact nip amount between the magnet brush and the image bearing member is reduced by reduction of the magnet brush due to scattering of magnetic particles.

(2) Poor image exposure and poor developing at an area of the image bearing member to which the scattered magnetic particles are adhered.

(3) Poor toner density in developer when the scattered magnetic particles are collected in the developing apparatus.

(4) Transferring of the scattered magnetic particles onto a transferring material at a transferring portion.

(5) Reverse Polarity electrification (image memory) or insulation destruction of the image bearing member upon application of transferring current.

(6) Poor electrification and poor image formation due to occurrence of damage of the surface of the image bearing member (drum scratch) upon adhesion of the magnetic particles and in the above items (3) to (5).

(7) In a color image formation, combination of the above disadvantages (1) to (6) to another process cartridge (another image forming portion) via the image bearing member or the transferring portion.

### SUMMARY OF THE INVENTION

An object of the present invention is to provide an image forming apparatus in which poor image formation due to scattering of magnetic particles can be prevented, and a process cartridge detachably attachable to such an image forming apparatus.

Another object of the present invention is to provide an image forming apparatus comprising a shiftable image bearing member, and electrifying means adapted to electrify the image bearing member and having magnetic particles contacted with the image bearing member and magnetic particle carrying means for magnetically holding and carrying the magnetic particles, and wherein a peak position of magnetic flux density of the magnetic particle carrying means near the image bearing member is located at a downstream side of a most approaching position between the magnetic particle carrying means and the image bearing member in a shifting direction of the image bearing member, and a process cartridge detachably attachable to such an image forming apparatus.

The other objects and features of the present invention will be more apparent from the following detailed explanation of the invention referring to the accompanying drawings.

### BRIEF DESCRIPTION OF THE DRAWINGS

FIG. 1 is a view showing an image forming apparatus according to an embodiment of the present invention;

FIG. 2 is a view showing a layer structure of a photosensitive drum;

FIG. 3 is a view showing an electrifying device;

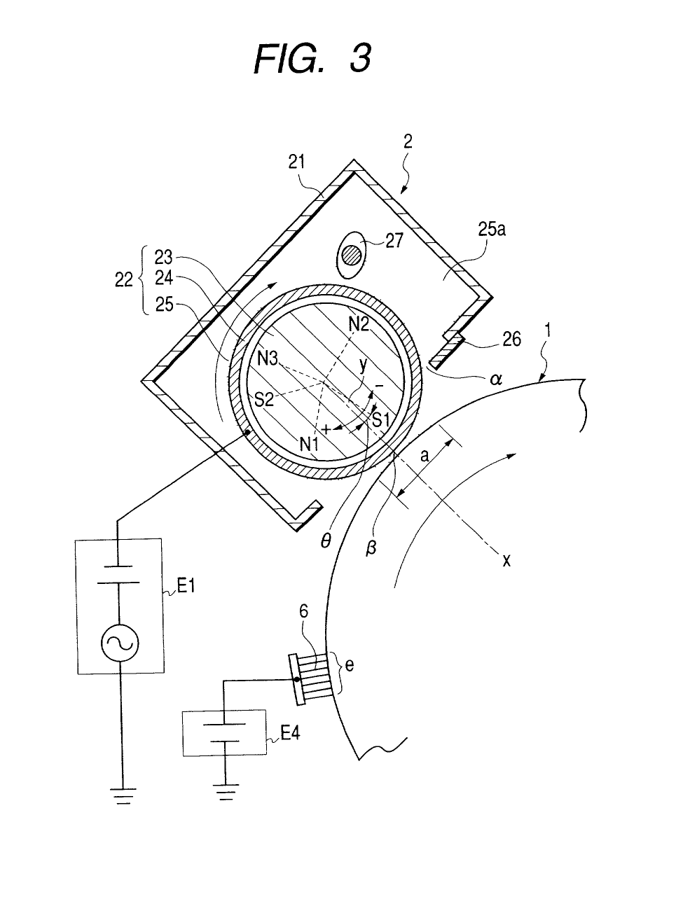

FIG. 4 is a graph showing a relationship between passage sheets number and magnetic particle discrete quantity;

FIG. 5 is a view showing a developing apparatus; and

FIG. 6 is a view showing an image forming apparatus according to another embodiment of the present invention.

### DETAILED DESCRIPTION OF THE PREFERRED EMBODIMENTS

<First Embodiment>

(1) Schematic Construction of Image Forming Apparatus

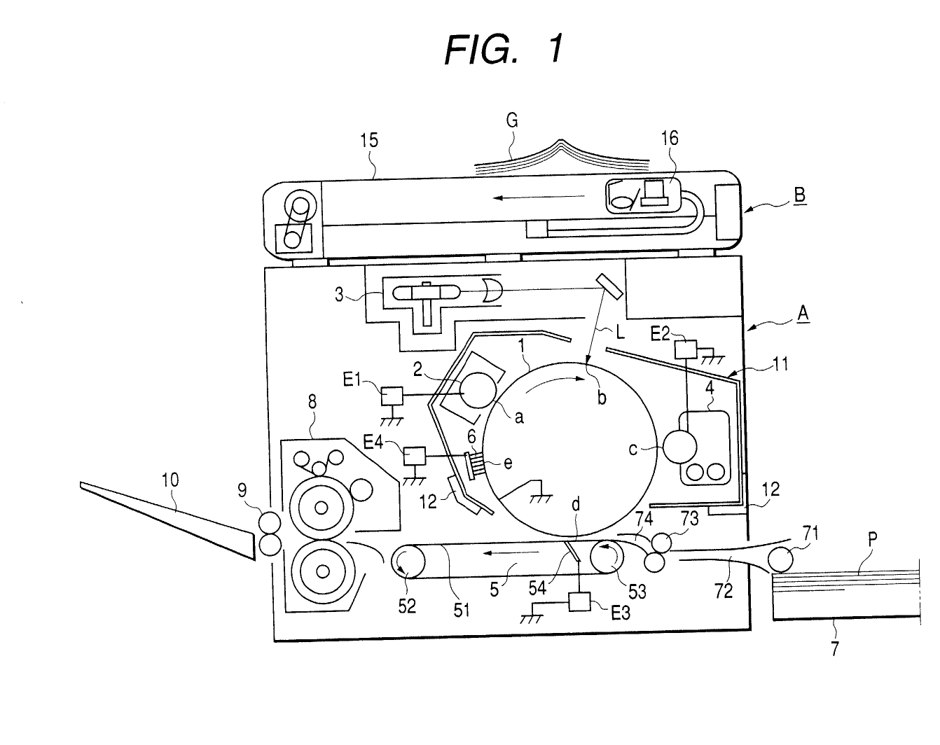

FIG. 1 is a schematic constructural view of an image forming apparatus according to the present invention. In this embodiment, the image forming apparatus is embodied as a laser printer of transfer electrophotographic process type, magnet brush electrifying type, reversal developing type, cleaner-less type and process cartridge detachable type. The printer includes a main body B, and an image reading device (image scanner) B mounted on the main body of the printer.

(a) Image Reading Device B

In the image reading device B, an original G is rested on an original glass plate (platen glass) 15 secured to an upper surface of the body with an imaged surface facing downwardly, and the original is covered by an original cover (not shown).

An original reading unit 16 includes an original lighting lamp, a short focus lens array, and a CCD sensor. When a copy button (not shown) is depressed, the original reading unit 16 is forwardly shifted from a home position (shown by the solid line in FIG. 1) at the right side below the original glass plate 15 to the left along a back surface of the glass plate, and, when the unit reaches a predetermined left limit, the unit is shifted backwardly to the home position shown by the solid line (reciprocal movement).

During the forward shifting movement of the unit 16, the downwardly facing imaged surface of the original G is successively lighted from the right to the left by the original lighting lamp of the image reading unit 16, and light (light signal) reflected from the original is focused onto the CCD sensor by the short focus lens array.

The CCD sensor includes a light receiving portion, a transferring portion and an output portion. In the light receiving portion, the light signal is converted into a charge signal, and, in the transferring portion, the charge signal is transferred to the output portion in synchronous with a clock pulse, and, in the output portion, the charge signal is converted into a voltage signal which is in turn subjected to amplifying and low impedance treatment and then is outputted. The analogue signal obtained in this way is subjected to known image treatment to convert it into a digital signal which is in turn sent to the main body A of the printer.

That is to say, by the image reading device B, the image information of the original G is photo-electrically read as a time-lapse electrical digital pixel signal (image signal).

(b) Main Body A of Printer

In the main body A of the printer, a rotatable drum-shaped electrophotographic photosensitive member (referred to as “photosensitive drum” hereinafter) 1 as an image bearing member is a negatively charged OPC photosensitive member having a charge injecting surface layer. The photosensitive member will be fully described in the Item (2) hereinbelow.

The photosensitive drum 1 is rotatingly driven around a center line thereof at a predetermined peripheral speed in a clockwise direction shown by the arrow. When a copy signal is inputted, the photosensitive drum is uniformly charged (with −700 V in the illustrated embodiment) by a contact electrifying device 2 at an electrifying section (electrifying area; electrifying nip portion). The contact electrifying device 2 according to the illustrated embodiment is a magnet brush electrifying device (injecting charger). The electrifying device 2 will be fully described in the Item (3) hereinbelow.

In an exposing section b, when the uniformly charged surface of the photosensitive drum 1 is subjected to scanning exposure L by a laser beam outputted from a laser scanning portion (laser scanner) 3 as an image information writing device and modulated in accordance with the image signal sent from the image reading device B to the main body A of the printer, an electrostatic latent image corresponding to the image information of the original G photo-electrically read by the image reading device B is formed on the surface of the rotating photosensitive drum 1.

The laser scanning portion 3 includes a light emitting signal generator, a solid-state laser element, a collimator lens system, and a polygon mirror. When the surface of the photosensitive drum is subjected to the laser scanning exposure L by the laser scanning portion 3, first of all, the solid-state laser element is flashed (turned ON/OFF) at a predetermined timing by the light emitting signal generator in responses to the inputted image signal. The laser light emitted from the solid-state laser element is converted into a substantially parallel light flux by the collimator lens system. The light flux is scanned by the polygon mirror rotated at a high speed and is focused on the surface of the photosensitive drum 1 as a spot by means of an fθ lens group. By such laser scanning, exposure distribution corresponding to one scanned area of the image is formed on the surface of the photosensitive drum 1, and, as the photosensitive drum 1 is further rotated, for each scanning, the surface of the photosensitive drum is scrolled by a predetermined amount in a direction perpendicular to the scanning direction, with the result that exposure distribution corresponding to the image signal is ultimately formed on the surface of the rotating photosensitive drum 1.

The electrostatic latent image formed on the surface of the photosensitive drum 1 is developer as a toner image by a developing apparatus 4 at a developing section c (reversal developing in the illustrated embodiment). In the illustrated embodiment, the developing apparatus 4 is a developing apparatus of two-component contact developing type. The developing apparatus 4 will be fully described in the Item (4) hereinbelow.

On the other hand, transferring materials P as recording materials contained in a sheet feeding cassette 7 are fed out one by one by means of a sheet feeding roller 71, and the fed material is supplied into the main body A of the printer through a sheet path 72. Then, the transferring material is fed to a transferring section (transfer nip portion) d as a contact area between the photosensitive drum 1 and a belt-type transferring device 5 as transferring means through a sheet path 74 by a registration roller pair 73 at a predetermined control timing.

The toner image formed on the surface of the photosensitive drum 1 is electrostatically transferred onto the transferring material P supplied to the transferring section d by means of a transferring charge blade 54 disposed inside of a transferring belt 51. The transferring device 5 will be fully described in the Item (5) hereinbelow.

The transferring material P which was passed through the transferring section d and to which the toner image was transferred is separated from the surface of the photosensitive drum 1 and then is sent to a fixing device 8 through a transferring belt extension of the transferring device 5. In the fixing device, the toner image is thermally fixed to the transferring material. Thereafter, the transfer material is discharged onto a discharge tray 10 out of the printer as an image formed matter (copy; print) by means of a discharge roller pair 9.

An auxiliary charger 6 comprises a conductive brush contacted with the photosensitive drum 1 at a downstream side of the transferring section d and at an upstream side of the electrifying section a in the rotational direction of the photosensitive drum. There is a contact area e between the conductive brush 6 and the photosensitive drum 1.

A cleaner-less system and the conductive brush 6 will be fully described in the Item (6) hereinbelow.

In the illustrated embodiment, four process means such as the photosensitive drum 1, electrifying device 2, developing apparatus 4 and conductive brush 6 are integrally incorporated into a process cartridge 11 which is detachably attachable to the main body A of the printer. The main body A of the printer has mounting/dismounting guides 12 for the process cartridge 11, which guides also act as positioning support members. When the process cartridge 11 is mounted within the main body A of the printer at a predetermined position, the process cartridge is coupled to the main body A of the printer mechanically and electrically to permit the operation of the main body A of the printer. Combination of process means incorporated into the process cartridge 11 is not limited to the above-mentioned example.

The process cartridge may integrally include electrifying means, developing means or cleaning means, and an electrophotographic photosensitive member as a cartridge unit which can detachably mounted to a main body of an image forming apparatus, or may integrally include at least one of electrifying means, developing means and cleaning means, and an electrophotographic photosensitive member as a cartridge unit which can detachably mounted to a main body of an image forming apparatus, may integrally include at least developing means, and an electrophotographic photosensitive member as a cartridge unit which can detachably mounted to a main body of an image forming apparatus.

(2) Photosensitive Drum 1

Although an organic photosensitive member normally utilized can be used as the photosensitive drum 1 as the image bearing member, desirably, when a photosensitive member including material having resistance of 10⁹ to 10¹⁴ Ω·cm on an organic photosensitive body or an amorphous silicone photosensitive member is used, charge injecting electrification can be realized, thereby preventing occurrence of ozone and reducing power consumption. Further, electrifying ability can be improved.

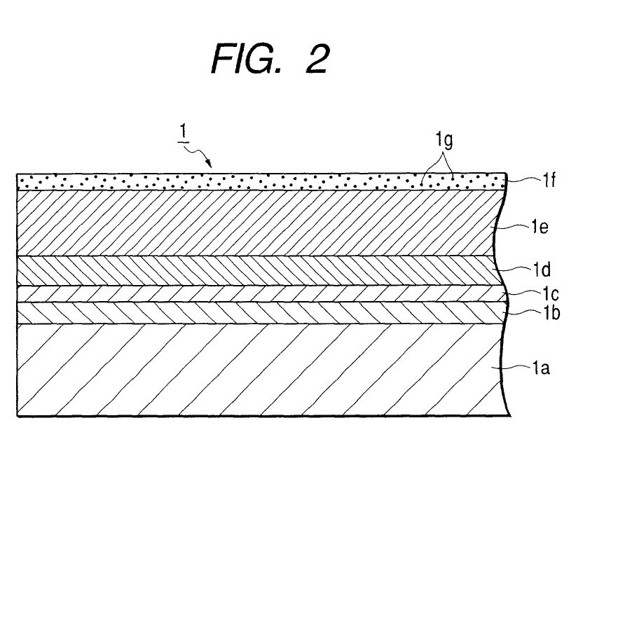

In the illustrated embodiment, as shown by a layer structure in FIG. 2, the photosensitive drum 1 is a negatively charged organic photosensitive member having a charge injecting surface layer and is constituted by providing the following five layers (first to fifth layers) on an aluminium drum substrate (referred to as “aluminium substrate” hereinafter) having a diameter of 30 mm from the below.

First layer 1b: Underground layer which is a conductive layer having a thickness of 20 μm for covering defect of the aluminium substrate 1a.

Second layer 1c: Positive charge injection preventing layer which is a middle resistance layer having a thickness of 1 μm and resistance of about 1×10⁶ Ω·cm adjusted by amylane resin and methoxy-methyl nylon and acting to prevent positive charges injected from the aluminium substrate 1a from cancelling negative charges electrified on the surface of the photosensitive member.

Third layer 1d: Charge generating layer which is a layer having a thickness of about 0.3 μm and is obtained by dispersing pigment of disazo group into resin and which can generate pairs of positive and negative charges when subjected to exposure.

Fourth layer 1e: Charge transporting layer formed from P-type semiconductor obtained by dispersing hydrazone into polycarbonate resin. Accordingly, the negative charges electrified on the surface of the photosensitive member cannot be shifted from this layer, and only the positive charges generated in the charge generating layer 1d can be transported onto the surface of the photosensitive member.

Fifth layer 1f: Charge injecting layer which is a coating layer formed from material obtained by dispersing SnO₂ super-fine particles as conductive particles 1g into insulative resin. More specifically, SnO₂ particles having particle diameter of about 0.03 μm and obtained by doping antimony as light permeable insulation filler into the insulative resin to reduce the resistance (permit conduction) is dispersed into resin by 70 weight %, thereby obtaining coating liquid.

By coating such coating liquid mixed in this way by an appropriate coating method such as a dipping coating method, a spray coating method, a roll coating method or a beam coating method, the charge injecting layer having a thickness of about 3 μm.

(3) Magnet Brush Electrifying Device 2

Magnet brush electrifying means 22 as contact electrifying means is disposed within an electrifying container (housing of the device) 21. In the illustrated embodiment, the magnet brush electrifying means 22 is of rotating sleeve type comprising a magnet roller 23 as a magnetic field generating member fixedly supported in a non-rotating fashion, a conductive non-magnetic sleeve (electrifying sleeve or injecting sleeve; referred to as “electrifying sleeve” hereinafter) 24 as a rotary member rotatably mounted around the magnet roller coaxially and having an outer diameter of 16 mm, and a magnet brush 25 formed from conductive magnetic particles (injecting magnetic particles or injection electrifying magnetic particles or electrifying carrier; referred to as “electrifying carrier” hereinafter) adhered to and held by an outer peripheral surface of the electrifying sleeve 24 by a magnetic force of the magnet roller 23 disposed within the electrifying sleeve. A blade 26 for regulating a thickness of the magnet brush 25 is secured to the housing 21. An agitating member 27 is disposed within the housing 21 above the electrifying sleeve. Incidentally, the magnet roller 23 and the sleeve 24 constitute magnetic particle carrying means for magnetically holding and carrying the magnetic particles.

In the illustrated embodiment, a most approaching gap (S-B gap) a between the electrifying sleeve 24 and the layer thickness regulating blade 26 is set to 800 μm. Further, a most approaching gap (S-D gap) β between the electrifying sleeve 24 and the photosensitive drum 1 is set to 500 μm in the illustrated embodiment.

The electrifying device 2 is disposed substantially in parallel with the photosensitive drum 1 in such a manner that the magnet brush 25 of the magnet brush electrifying means 22 is contacted with the surface of the photosensitive drum 1. In this case, a contact nip width (width of the electrifying section a) of the magnet brush 25 with respect to the photosensitive drum 1 is adjusted to have a predetermined value. In the illustrated embodiment, the nip width with respect to the photosensitive drum 1 is adjusted to be about 6 mm.

Preferably, the electrifying carrier constituting the magnet brush 25 has mean particle diameter of 10 to 100 μm and saturated magnetism of 20 to 250 kA/m (emu/cm³) and resistance of 1×10² to 1×10¹⁰ Ω·cm. If it is considered that there is defect in the photosensitive drum 1 such as a pin-hole, it is preferable that the resistance is greater than 1×10⁶ Ω·cm. In order to improve the electrifying ability, since the resistance 1d decreased as small as possible, in the illustrated embodiment, electrifying carrier having mean particle diameter of 25 μm and saturated magnetism of 200 kA/m and resistance of 5×10⁶ Ω·cm is used.

Here, the resistance value of the electrifying carrier is measured by applying load of 6.6 kg after electrifying carrier of 2 grams is housed within a metallic cell having a bottom area of 228 mm² and then by applying voltage of 100 V.

As the electrifying carrier, resin carrier obtained by dispersing magnetite as magnetic material into resin and by adding carbon black for resistance adjustment, or carrier obtained by oxidizing and reducing surface of magnetic (simple substrate) such as ferrite for resistance adjustment, or carrier obtained by coating surface of magnetite (simple substrate) such as ferrite with resin for resistance adjustment may be used.

The electrifying sleeve 24 of the magnet brush electrifying means 22 is rotated in a clockwise direction shown by the arrow, i.e., in a counter direction opposite to the rotational direction of the photosensitive drum 1 in the electrifying section a. In the illustrated embodiment, the photosensitive drum 1 is rotated at a rotational speed of 100 mm/sec, while, the electrifying sleeve 24 is rotated at a rotational speed of 150 mm/sec.

As the electrifying sleeve 24 is rotated, the magnet brush 25 of the electrifying carrier is rotated and conveyed in the same direction, and, the thickness of the magnet brush is regulated by the layer thickness regulating blade 26, so that the surface of the photosensitive drum 1 is slidingly contacted with the magnet brush 25 evenly in the electrifying section a as the contact area between the magnet brush 25 and the photosensitive drum 1.

The agitating member 27 serves to strip the electrifying carrier returned from the electrifying section a to an electrifying carrier reservoir portion 25a within the electrifying container 21 from the surface of the electrifying sleeve and to agitate the stripped carrier with the electrifying carrier in the electrifying carrier reservoir portion 25a.

The charges is given from the electrifying carrier of the magnet brush 25 onto the photosensitive drum 1 by applying predetermined electrifying bias from a bias power supply E1 to the electrifying sleeve 24, thereby electrifying the photosensitive drum with potential corresponding to the electrifying voltage. The faster the rotational speed the better the electrifying uniformity.

In the illustrated embodiment, the vibrating voltage obtained by overlapping direct current voltage DC of −700 V with alternating voltage (alternate current voltage) AC is applied as the electrifying bias.

In the illustrated embodiment, as mentioned above, since the photosensitive drum 1 is provided at its surface with the charge injecting layer 1f, the photosensitive drum 1 is charged by the charge injecting electrification. That is to say, electrifying potential substantially equal to direct current component DC (−700 V) of the DC+AC bias applied to the electrifying sleeve 24 can be obtained on the surface of the photosensitive drum.

In the magnet roller 23 non-rotatingly secured within the electrifying sleeve 24, magnetic poles S1, N1, S2, N3 and N2 are magnetized along the circumference of the magnet roller 23. The S1 pole is a main electrifying pole located substantially in correspondence to the S-D gap β as the most approaching position between the electrifying sleeve 24 and the photosensitive drum 1. The N1, S2, N3 and N2 poles are magnet brush (electrifying carrier) conveying poles. As the electrifying sleeve 24 is rotated, the magnet brush 25 returned from the electrifying section a to the electrifying carrier reservoir portion 25a within the electrifying container 21 is subjected to peeling action on the electrifying sleeve 24 by a repelling magnetic field between N3 and N2 poles (same polarity poles) of the magnet roller 23, and the electrifying carrier of the magnet brush subjected to the peeling action is stripped from the surface of the electrifying sleeve by the agitating member 27, and the stripped electrifying carrier is agitated and mixed with the electrifying carrier in the electrifying carrier reservoir portion 25a.

The layer thickness regulating blade 26 is spaced apart from the electrifying sleeve 24 with the gap (S-B gap) α of 800 μm at an upper side of the main electrifying pole S1, i.e., at a position at an upstream side of the main electrifying pole S1 in the rotational direction of the electrifying sleeve, and the layer thickness regulating blade 26 forms a thin layer on the charging electrifying sleeve 24 by using the electrifying carrier stored in the electrifying carrier reservoir portion 25a within the electrifying container.

Although the electrification using the magnet brush 25 can be effected by an arrangement for coating an amount of electrifying carrier corresponding to one circumference of the electrifying sleeve 24 without utilizing the layer thickness regulating blade 26, when much electrifying carrier is stored in the electrifying container and the thin layer is coated on the electrifying sleeve 24 by the layer thickness regulating blade 26, even if the electrifying carrier is leaked more or less, the coating amount is kept unchanged, thereby stabilizing the electrifying nip a between the magnet brush 25 and the photosensitive drum 1.

Further, as is in the printer according to the illustrated embodiment, in case of the cleaner-less system, since the residual toner is mixed with the magnet brush 25 of the magnet brush electrifying means 22, contamination of electrifying carrier with the residual toner will occur. Regarding such contamination, the greater the amount of the electrifying carrier the more contamination per unit amount may be reduced. However, since the contamination of the electrifying carrier with the toner occurs in a share (area or portion or range) within the electrifying carrier reservoir portion 25a at the upstream side of the layer thickness regulating blade 26, if the amount of the electrifying carrier is increased, the amount of the reserved electrifying carrier will also be increased, with the result that the share is increased, which cannot improve the contamination.

In consideration of the above fact, by stripping the electrifying carrier born on the electrifying sleeve 24 as the magnet brush 25 and holding it within the electrifying container 21 and by exchanging the electrifying carrier held in the electrifying container 21 to the electrifying carrier on the electrifying sleeve 24, the amount of the electrifying carrier can be increased without increasing the electrifying carrier reserved amount at the upstream side of the layer thickness regulating blade, thereby suppressing the contamination of the electrifying carrier with the toner, and, if the electrifying carrier is leaked more or less, the coating amount of the electrifying carrier on the electrifying sleeve 24 will not be changed, thereby stabilizing the electrifying nip a between the magnet brush 25 of the electrifying carrier and the photosensitive drum 1.

Although the electrifying carrier in the electrifying nip a as the contact area between the magnet brush 25 and the photosensitive drum 1 is magnetically held on the electrifying sleeve 24 by the magnetic force of the magnet roller 23, as mentioned above, there arises the “carrier adhesion” problem that a part of the electrifying carrier is separated from the magnet brush and is adhered to the photosensitive drum 1. The reason is that the separation of the electrifying carrier at the downstream end of the electrifying nip a in the rotational direction of the photosensitive drum is particularly noticeable and the magnetic holding force on the electrifying sleeve 24 for holding the electrifying carrier is insufficient at that portion.

Regarding the main electrifying pole S1 corresponding to the electrifying nip a, discrete (separation) conditions of the electrifying carrier established when positions of the main electrifying pole are changed were checked.

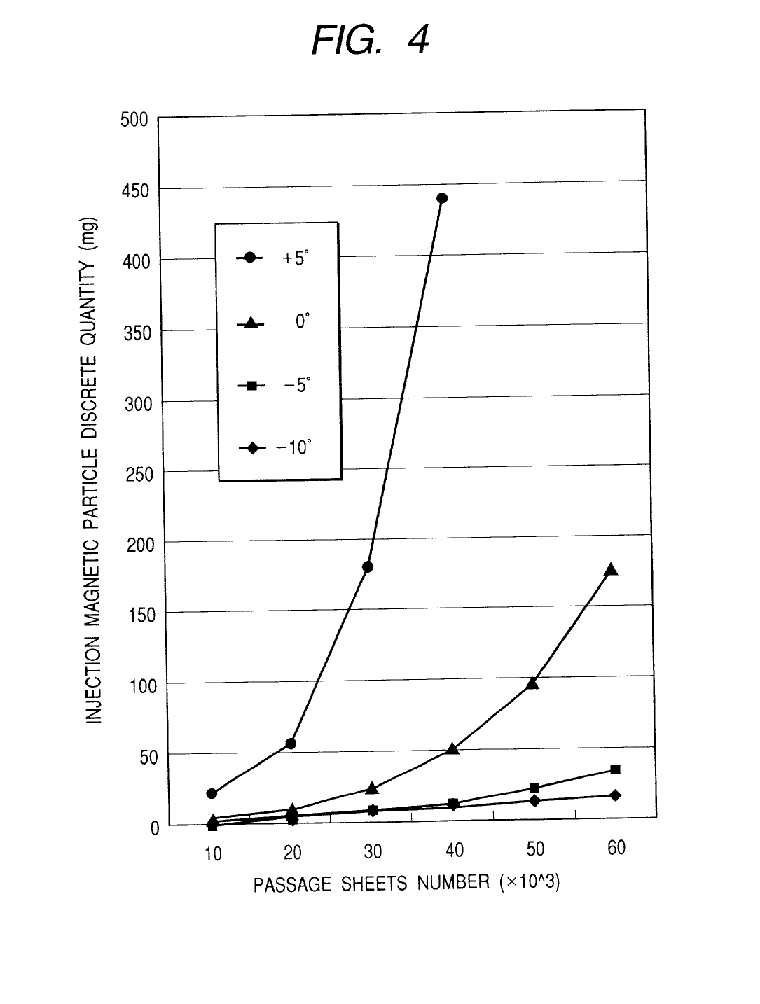

That is to say, when it is assumed that a line x connecting between the center of the magnet roller 23 and the center of the photosensitive drum 1 is defined as 0° reference line, an angle θ between the reference line x and a line y connecting between the center of the magnet roller 23 and the center of the S1 pole (peak position of magnetic flux density) is defined as a main electrifying pole position angle, an angle at an upstream side of the reference line x in the rotational direction of the electrifying sleeve is defined as minus (−) angle and angle at a downstream side of the reference line x in the rotational direction of the electrifying sleeve is defined as plus (+) angle regarding the above-mentioned angle θ, by changing the angle θ, the discrete conditions of the electrifying carrier with respect to the positions of the main electrifying pole were measured quantitatively. Results are shown in FIG. 4.

After the developer within the developing apparatus 4 was removed and the sheet passage was effected, the discrete quantity of the electrifying carrier (injecting magnetic particles) was determined by collecting the electrifying carrier separated from the magnet brush 25 of the magnet brush electrifying means 22 and adhered to the photosensitive drum 1 by means of the developing sleeve of the developing apparatus 4 and by measuring the collected electrifying carrier.

As can be seen from FIG. 4, as the main electrifying pole position angle θ advances toward the minus angle, the discrete quantity of the electrifying carrier is greatly decreased. The reason is that the magnetic holding force of the main electrifying pole S1 strongly acts on the downstream end of the electrifying section a in the rotational direction of the photosensitive drum, thereby preventing the electrifying carrier from separating from the downstream end.

Further, when the main electrifying pole position angle θ advances toward the plus angle, as the passage sheets number is increased, the discrete quantity per unit time is increased. Here, when the separated electrifying carrier was collected and the resistance value thereof was measured, it was found that the resistance value is gradually decreased from a predetermined value as the passage sheets number is increased.

From the above fact, since the time-lapse change in the discrete quantity of the electrifying carrier is small when the main electrifying pole position angle θ directs toward the minus angle, by setting the position of the main electrifying pole, i.e., peak position of the magnetic flux density of the main electrifying pole S1 at a downstream side of the most approaching position (S-D gap β position) between the electrifying sleeve 24 and the photosensitive drum 1 in the rotational direction of the photosensitive drum, the change in resistance value of the electrifying carrier can be well coped with.

In the illustrated embodiment, the peak position of the magnetic flux density of the main electrifying pole S1 is set at a downstream side of the most approaching position between the electrifying sleeve 24 and the photosensitive drum 1 in the rotational direction of the photosensitive drum, thereby substantially preventing the carrier adhesion to extend the service lives of the electrifying device and the image forming apparatus, and, thus, thereby providing good image formation for a long term.

(4) Developing Apparatus 4

Methods for developing the electrostatic latent image with toner are generally divided into the following four groups a to d.

a. A method in which non-magnetic toner is coated on a developing sleeve by a blade or magnetic toner is coated on a developing sleeve by a magnetic force, and the coated toner is conveyed to a photosensitive drum and development is effected on the photosensitive drum in a non-contact condition (one-component non-contact development);

b. A method in which the toner coated in the above-mentioned way is conveyed to a photosensitive drum and development is effected on the photosensitive drum in a contact condition (one-component contact development);

c. A method in which mixture of toner particles and magnetic carrier is used as developer, and the developer is conveyed to a photosensitive drum by a magnetic force and development is effected on the photosensitive drum in a contact condition (two-component contact development); and

d. A method in which mixture of toner particles and magnetic carrier is used as developer, and the developer is conveyed to a photosensitive drum by a magnetic force and development is effected on the photosensitive drum in a non-contact condition (two-component non-contact development).

In the viewpoint of high image quality and high stability, the two-component contact developing method has widely been used.

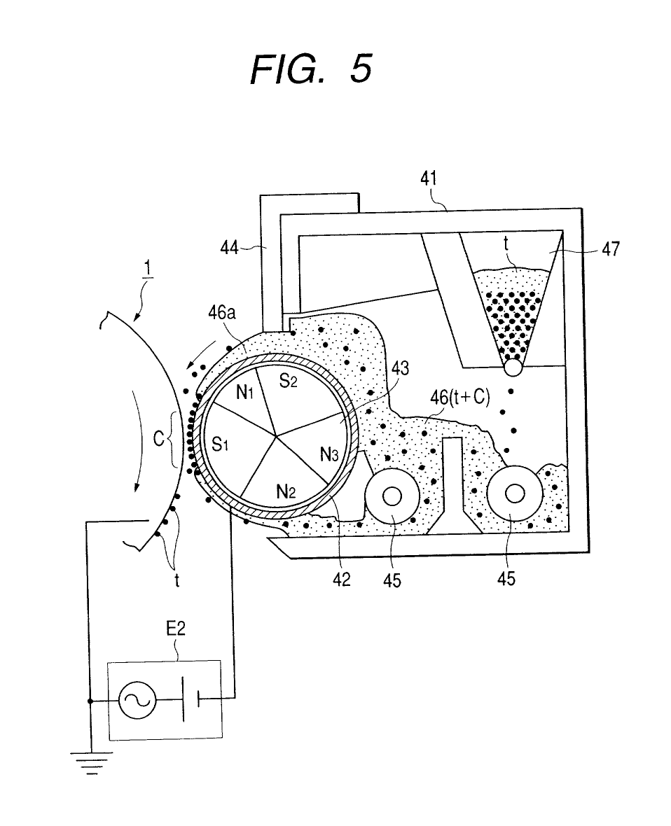

FIG. 5 shows a schematic construction of the developing apparatus 4 according to the illustrated embodiment. The developing apparatus 4 according to the illustrated embodiment is a developing apparatus of two-component magnet brush contact developing type in which mixture of non-magnetic negative toner particles and magnetic carrier particles (developing carrier) is used as the developer, and the developer is magnetically held on a developer carrying member as a magnetic brush layer which is in turn conveyed to the developing section, where the electrostatic latent image is developed as the toner image with reversal developing while contacting the developer with the surface of the photosensitive drum 1.

The developing apparatus 4 comprises a developing container 41, a developing sleeve 42 as a developer carrying member, a magnet roller 43 as a magnetic field generating member fixedly disposed within the developing sleeve 42, a developer layer thickness regulating blade 44 for forming a thin developer layer on the surface of the developing sleeve, a developer agitating and conveying screw 45, and two-component developer 46 contained in the developing container 41 and including mixture of non-magnetic negative toner particles t and magnetic carrier particles C.

In the two-component developer 46 used in the illustrated embodiment, the toner particles t are obtained by externally adding titanium oxide having mean particle diameter of 20 nm to negative chargeable toner formed by a suspension polymerizing method and having mean particle diameter of 6 μm by 1 weight %, and magnetic carrier having saturated magnetism of 205 kA/m and having mean particle diameter of 25 μm is used as the developing magnetic carrier C. The toner t and the developing magnetic carrier C are mixed with weight ratio of 7:93.

Since the toner particles formed by the polymerizing method have near-spherical shapes, the external additive is uniformly coated on the toner particles. Thus, the extremely good mold releasing ability with respect to the photosensitive drum can be achieved.

The developing sleeve 42 is arranged to have the most approaching distance (gap) of about 500 μm between the sleeve and the photosensitive drum 1 at least during the developing operation so that a developer magnet brush thin layer 46a born on the outer surface of the developing sleeve 42 is contacted with the surface of the photosensitive drum 1. A contact area between the developer magnet brush thin layer 46a and the photosensitive drum 1 is the developing section c.

The developing sleeve 42 is rotated around the fixed magnet roller 43 at a predetermined rotational speed in an anti-clockwise direction shown by the arrow; meanwhile, the magnet brush of the developer 46 is formed on the outer surface of the sleeve by the magnetic force of the magnet roller 43 within the developing container 41. The developer magnet brush is conveyed by the rotation of the developing roller 42, and the thickness of the layer of the developer is regulated by the blade 44 to form the developer magnet brush thin layer 46a having a predetermined thickness which is in turn conveyed from the developing container to the developing section c, where the thin layer is contacted with the surface of the photosensitive drum 1. As the sleeve 42 is further rotated, the developer is returned to the interior of the developing container 41.

That is to say, first of all, as the developing roller 42 is rotated, the developer 46 picked-up by an N₃ pole of the magnet roller 43 is advanced through S₂ to N₁ poles; meanwhile, the developer is regulated by the regulating blade 44 to form the thin layer 46a of the developer 46 on the developing sleeve 42. When the developer thin layer 46a reaches a main developing pole S₁ in the developing section, upright toner-chains are formed by the magnetic force. The electrostatic latent image on the photosensitive drum 1 is developed as the toner image by the toner-chain developer layer 46a. Thereafter, the developer on the developing sleeve 42 is returned to the interior of the developing container 41 by a repelling magnetic field between N₂ and N₃ poles.

In the illustrated embodiment, oscillation voltage obtained by overlapping negative DC voltage of −500 V with alternating voltage having amplitude Vpp of 1500 V and frequency Vf of 2000 Hz is applied as developing bias between the developing sleeve 42 and the conductive drum substrate of the photosensitive drum 1.

In general, in the two-component developing method, when the alternating voltage is applied, although developing efficiency is increased to obtain high image quality, there is the danger of generating fog. Thus, normally, by providing potential difference between the DC voltage applied to the developing apparatus 4 and the surface potential of the photosensitive drum 1, the fog is prevented. Such potential difference for preventing the fog is called as fog removal potential (Vback), and, by such potential difference, the toner is prevented from adhering to a non-imaging area of the photosensitive drum 1 during the developing operation.

Toner density (mixing ratio between the toner and the carrier) of the developer 46 within the developing container 41 is gradually decreased since the toner is consumed during the development of the electrostatic latent image. The toner density of the developer 46 within the developing container 41 is detected by detecting means (not shown). If the toner density is decreased to predetermined allowable lower limit density, new toner t is replenished from a toner replenishing portion 47 to the developer 46 within the developing container, thereby always keeping the toner density of the developer 46 within the developing container 41 a predetermined allowable range.

(5) Transferring Device 5

In the illustrated embodiment, the transferring device 5 is of transfer belt type as mentioned above. The transferring device comprises an endless transfer belt 51 mounted around and between a driving roller 52 and a driven roller 53 and rotated in a direction opposite to the rotational direction of the photosensitive drum 1 at a speed substantially the same as the rotational speed of the photosensitive drum 1, a transfer electrifying blade 54 disposed inside of the transfer belt 51 and adapted to urge an upper run of the transfer belt 51 against the photosensitive drum 1 to form the transferring section d therebetween. When transferring bias is applied to the transfer electrifying blade from a transferring bias applying power supply E3, the electrification having polarity opposite to that of the toner is effected from a back surface of the transferring material P. In this way, the toner image on the photosensitive drum 1 is electrostatically transferred onto the surface of the transferring material P being passed through the transferring section d.

In the illustrated embodiment, the belt 51 is formed from polyimide resin having a film thickness of 75 μm. Material of the belt 51 is no limited to polyimide resin, but may be plastics such as polycarbonate resin, polyethylene terephthalate resin, polyvynylidene fluoride resin, polyethylene naphthalate resin, polyether ether ketone resin, polyether sulfone resin or polyurethane resin, or rubber of fluorine group or silicon group. The thickness is not limited to 75 μm, but may generally be 25 to 2000 μm, and preferably be 50 to 150 μm.

Further, the transfer electrifying blade 54 has resistance of 1×10⁵ to 1×10⁷ Ω, thickness of 2 mm and length of 306 mm. The transferring is effected by applying bias of +15 μA to the transfer electrifying blade 54 with constant current control.

(6) Cleaner-less System

1. After the toner image was transferred to the transferring material P, when the photosensitive drum 1 is further rotated, transfer-residual toner remaining on the surface of the photosensitive drum 1 is brought to a conductive brush 6 as the auxiliary charger disposed between the transferring section d and the electrifying section a and contacted with the surface of the photosensitive drum 1.

In the illustrated embodiment, the conductive brush 6 is a conductive layon fiber brush having fiber length of 6 mm. An abut nip at a contact area e between the conductive brush 6 and the photosensitive drum 1 is 7 mm. DC voltage of +500 V having polarity opposite to the electrifying polarity is applied the conductive brush 6 from a power supply E4.

The transfer-residual toner includes toner negatively charged (normal electrifying polarity), toner positively charged due to the transferring bias and/or peel discharging, and toner in which minus electrification is weakened or electricity is removed therefrom. The transfer-residual toner is agitated by the conductive brush 6 in the contact area e between the conductive brush 6 and the photosensitive drum 1, with the result that toner weakly electrified (among the toner negatively charged (normal electrifying polarity), the toner positively charged due to the transferring bias and/or peel discharging, and the toner in which minus electrification is weakened or electricity is removed therefrom) is positively adhered to the conductive brush 6 by an electrical attracting force of the plus bias applied to the conductive brush 6, and the other toner is positively electrified by the friction between the toner and the brush and the plus applied bias, and the positively electrified toner is discharged from the conductive brush 6 onto the surface of the photosensitive drum 1 to be adhered again to the photosensitive drum by the electrical repelling force between such toner and the plus applied bias on the conductive brush 6.

Accordingly, the transfer-residual toner is electrified substantially positively opposite to the normal electrifying polarity by means of the conductive brush 6 and is brought to the electrifying section a by the further rotation of the photosensitive drum 1.

2. The transfer-residual toner on the photosensitive drum 1 brought to the electrifying section a is picked up by the magnet brush 25 of the magnet brush electrifying means 22 to be electrified and temporarily collected. In this case, since the transfer-residual toner brought to the electrifying section a was electrified substantially positively as mentioned above, it can be temporarily collected efficiently by the electrical attracting force of the magnet brush electrifying means 22 to which the negative electrifying bias is applied. In this case, when the alternating voltage is applied to the magnet brush electrifying means 22, the transfer-residual toner can easily be picked up by the magnet brush 25 by oscillation effect due to the electrical field between the photosensitive drum 1 and the injecting sleeve 24.

The transfer-residual toner temporarily collected in the magnet brush 25 is efficiently re-electrified inversely from the reversal positive electrification to the normal negative electrification, by the negative bias applied to the magnet brush electrifying means 22 and friction between the toner and the magnet brush 25.

The transfer-residual toner temporarily collected in the magnet brush 25 and re-electrified to the normal negative electrification is discharged onto and adhered to the photosensitive drum 1 by the repelling force between the negative toner and the negative bias applied to the magnet brush electrifying means 22.

3. The toner discharged on the photosensitive drum 1 and re-electrified to the normal negative electrification is sent, by the subsequent rotation of the photosensitive drum 1, through the image exposing section b of the image exposing device 3 to the developing section c of the developing apparatus 4, where the toner is subjected to cleaning simultaneous with developing (collection simultaneous with developing) by means of the developing member of the developing apparatus 4.

The discharging of the toner from the magnet brush of the electrifying device 2 onto the surface of the photosensitive drum 1 is effected with uniform distribution, and, since the discharged toner quantity is small, even when the toner is passed through the image exposing section b, it does not interfere with the image exposing.

The cleaning simultaneous with developing is a method in which, during the next or subsequent process (i.e., the photosensitive drum 1 is subsequently electrified, a new latent image is formed by image exposure and the latent image is developed), the transfer-residual toner remaining on the photosensitive drum after the transferring is collected by the fog removal bias (fog removal potential difference Vback which is potential difference between the DC voltage applied to the developing apparatus 4 and the surface potential of the photosensitive drum 1). In case of reversal developing, the cleaning simultaneous with developing is effected under the action of the electrical field for collecting the toner from the dark portion potential area of the photosensitive drum to the developing member and the electrical field for adhering the toner from the developing member onto the light portion potential area of the photosensitive drum 1. When the imaging area on the photosensitive drum along the rotational direction of the photosensitive drum is linger than the peripheral length of the photosensitive drum 1, the collection simultaneous with developing is effected simultaneously with other image formation such as electrifying, exposing, developing and transferring.

Now, the cleaner-less system performing the above-mentioned functions 1. to 3. will be further explained briefly. As mentioned above, in the cleaner-less system, although the transfer-residual toner is collected by the developing apparatus 4 in the developing section c with cleaning simultaneous with developing, if the transfer-residual toner on the surface of the photosensitive drum 1 after the transferring is passed through the electrifying section a of the electrifying device 2 as it is, the above-mentioned ghost or fog will be generated. That is to say, even when the transfer-residual toner passes below the magnet brush contacted with the photosensitive drum 1, in almost all cases, since the history of the previous image remains on the photosensitive drum, under the setting of the magnet brush in the proper electrifying condition, the toner is not dispersed uniformly.

To avoid this, it is necessary that the transfer-residual toner reached to the electrifying section a by the rotation of the photosensitive drum 1 is picked up by the magnet brush 25 and the history of the previous image is erased. In this case, although the toner is not sufficiently picked up by the magnet brush 25 only by applying the DC voltage to the magnet brush electrifying means 22, when the alternating voltage is applied to the magnet brush electrifying means 22, the toner can be picked up by the magnet brush 25 relatively easily under the action of the oscillation effect due to the electrical field between the photosensitive drum 1 and the injecting sleeve 24.

However, depending upon the electrified quantity of the transfer-residual toner reached to the electrifying section a, it may be very difficult to pick up the toner into the magnet brush 25. Namely, since the transfer-residual toner was electrified, the potential difference between the magnet brush 25 and the photosensitive drum 1 and mirror symmetry force between the toner and the photosensitive drum affect a great influence upon the picking-up ability.

Although it is ideal that the surface potential of the photosensitive drum passed through the magnet brush electrifying means 22 is equal to the voltage applied to the magnet brush electrifying means, in actual, the electrifying section as the contact area between the magnet brush 25 and the photosensitive drum 1 has a certain width. Thus, even when the surface potential is ultimately equal to the voltage supplied, since adequate electrification cannot be obtained in the initial condition of passage through the magnet brush, there arises the potential difference between the magnet brush and the photosensitive drum. In the illustrated embodiment, since the dark portion potential Vdc of the magnet brush electrifying device is set to −700 V, under an initial condition of passage through the electrified region, in an area where the surface potential of the photosensitive drum is smaller than −700 V, although the positively electrified toner is picked up in the magnet brush, the negatively electrified toner is not picked up. Further, if the electrified amount of the transfer-residual toner is extremely great and the mirror symmetry force between the toner and the photosensitive drum is too great, the toner will remain on the drum. Thus, it is desirable that the transfer-residual toner is electrified positively (although it naturally be electrified negatively). However, even if the toner is not electrified positively, so long as the absolute value of the electrified amount is sufficiently small, it can be expected that such toner is forcibly removed by the magnet brush.

In fact, although the electrifying polarity of the transfer-residual toner is often reversed by the peel discharging during the transferring, even when the transferring efficient is equal, since the electrified amount distribution of the transfer-residual toner is greatly differentiated depending upon the transferring electrical current and the developer itself is deteriorated for the long term usage thereby to worsen the transferring efficiency, the ratio of negatively electrified toner remaining on the photosensitive drum is increased. To avoid this, it is preferable to provide means for increasing the transferring electrical current or for electrifying the transfer-residual toner to the opposite polarity.

To this end, in the illustrated embodiment, the conductive brush 6 as the auxiliary charger is urged against the photosensitive drum 1 between the transferring section d and the electrifying section a, and bias opposite to the electrifying bias is applied to the conductive brush. The positively charged transfer-residual toner is passed through the conductive brush 6. On the other hand, the negatively charged transfer-residual toner is caught by the conductive brush 6 temporarily, and after electricity removal, it is sent onto the photosensitive drum 1 again. In this way, the transfer-residual toner is can easily be picked up by the magnet brush, thereby eliminating the cause of occurrence of the ghost.

The conductive brush 6 as the auxiliary charger may be an auxiliary charger in the form of a conductive rubber roller or the like.

In this way, according to the illustrated embodiment, since the peak position of the magnetic flux density of the magnetic particle carrying member is located at the downstream side of the most approaching position between the magnetic particle carrying member and the member to be charged (image bearing member) in the rotational direction of the member to be charged, the magnetic holding force at the peak of the magnetic flux density of the magnetic particle carrying member strongly acts on the downstream end of the contact area between the magnet brush and the member to be charged in the rotational direction of the member to be charged, thereby preventing the magnetic particles from separating from that downstream end (i.e., collecting the magnetic particles charge-injected in the magnetic brush nip portion (at the upstream side) and adhered to the member to be charged, at the nip portion, without shifting together with the member to be charged and without leaking out of the electrifying device), and, the change in the resistance value of the magnetic particles can be coped with, with the result that the carrier adhesion is substantially prevented to extend the service lives of the electrifying device and the image forming apparatus, thereby providing good image formation for a long term.

<Second Embodiment>

In the image forming apparatus according to the first embodiment, in order to examine the effect obtained by changing the position of the main electrifying pole of the electrifying device 2, a sheet passing test (passage sheets test) was performed by using the actual image forming process.

The items to be examined or ascertained are as follows:

(1) Remaining amount of the electrifying carrier within the electrifying device 2 after the sheet passing test (up to the decrease of 1% OK);

(2) White void in the image on the recording paper (transferring material) due to poor image exposure;

(3) Change in toner density within the developing apparatus 4;

(4) Image memory on the recording paper; and

(5) Drum scratch image on the recording paper.

The sheet passing test in which 100,000 sheets are passed under image duty of 10% was performed, and the above items (1) to (5) were examined for every 1,000 sheets. The result is shown in the following Table 1. As a result, it was found the effect obtained by changing the position of the main electrifying pole of the electrifying device 2 is achieved for the respective items (1) to (5). Further, even when the main electrifying pole position angle θ is 0°, i.e., even when the main electrifying pole S1 is located just in alignment with the S-D gap β position, it was ascertained that the above items can well be coped with up to 50,000 sheets.

However, as can be seen from the Table 1, in order to collect the carrier substantially completely the angle θ is preferably selected to θ<0°, with the result that the better image can be formed.

TABLE 1

| | +5° | 0° | −5° | −10° | Remarks |
|---|---|---|---|---|---|
| Carrier remaining | x | Δ | ∘ | ∘ | Δ: 1.6% |
| amount | | | | | reduction |
| White void | x | ∘ | ∘ | ∘ | |
| Drum scratch | Δ | ∘ | ∘ | ∘ | Δ: OK up to |
| | | | | | 42,000 |
| Memory | x | ∘ | ∘ | ∘ | |
| Toner density | Δ | ∘ | ∘ | ∘ | Δ: OK up to |
| | | | | | 57,000 |

∘: no problem
x: problem

<Third Embodiment>

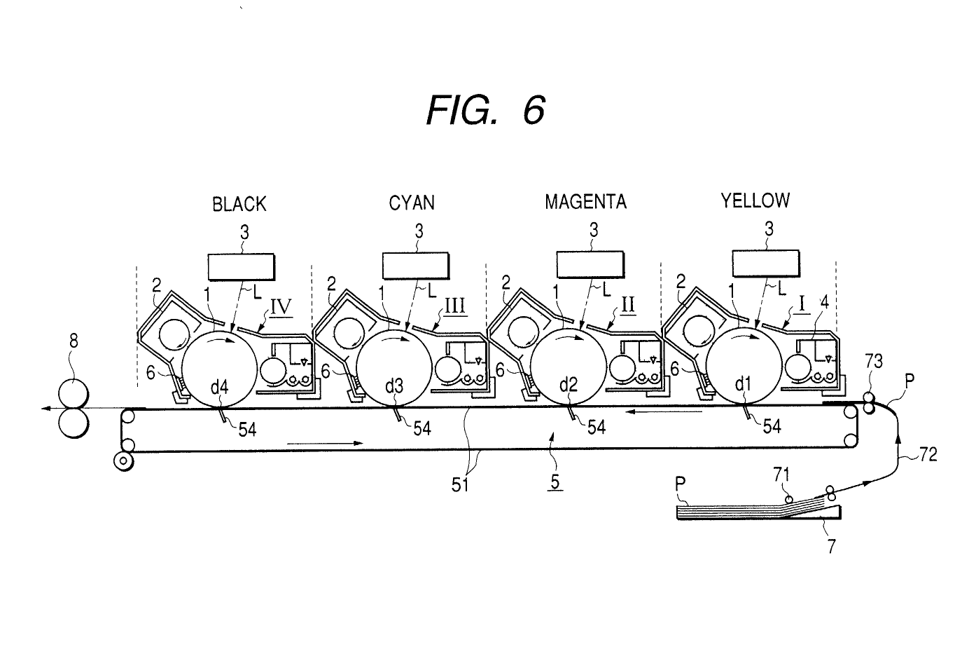

A third embodiment of the present invention relates to a full-color image forming apparatus of tandem type. FIG. 6 is a schematic constructural view of such an image forming apparatus.

First to fourth process cartridges I, II, III and IV are positioned within a main body of the image forming apparatus successively from right to left. Similar to the first embodiment, an image forming mechanism including the process cartridges I, II, III and IV is of transfer electrophotographic process, magnet brush electrifying, laser scan exposing, reversal developing and cleaner-less system type. Similar to the printer A according to the first embodiment, each of the process cartridges I, II, III and IV includes a photosensitive drum 1, a magnet brush electrifying device 2, a developing apparatus 4 and a conductive brush 6.

In the first process cartridge I, the surface of the photosensitive drum 1 is subjected to image exposure L corresponding to an yellow image component of a full-color image by means of an image exposing device 3 to form an electrostatic latent image which is in turn developed as an yellow toner image by the developing apparatus 4 with reversal developing. Similarly, in the second process cartridge II, the surface of the photosensitive drum 1 is subjected to image exposure L corresponding to a magenta image component of a full-color image by means of an image exposing device 3 to form an electrostatic latent image which is in turn developed as a magenta toner image by the developing apparatus 4 with reversal developing. In the third process cartridge III, the surface of the photosensitive drum 1 is subjected to image exposure L corresponding to a cyan image component of a full-color image by means of an image exposing device 3 to form an electrostatic latent image which is in turn developed as a cyan toner image by the developing apparatus 4 with reversal developing. In the fourth process cartridge IV, the surface of the photosensitive drum 1 is subjected to image exposure L corresponding to a black image component of a full-color image by means of an image exposing device 3 to form an electrostatic latent image which is in turn developed as a black toner image by the developing apparatus 4 with reversal developing.

On the other hand, transferring materials P contained in a sheet feeding cassette 7 are fed out one by one by means of a sheet feeding roller 73, and the fed-out transferring material is conveyed through a sheet path 72 and then is supplied onto an upper run of a transfer belt 51 of a transferring belt device 5 at a predetermined control timing by means of a registration roller pair 73. Predetermined transferring biases are applied from respective transferring bias applying power supplies (not shown) to transfer electrifying blades 54 disposed at first to fourth transferring positions d1 to d4 corresponding to the first to fourth process cartridges 1 to IV at predetermined control timings.

The transferring material P supplied onto the transfer belt 51 is electrostatically absorbed on and held by the surface of the transfer belt and is conveyed successively through the first to fourth transferring positions d1 to d4 as the transfer belt 52 is rotated. Meanwhile, the yellow toner image on the surface of the photosensitive drum 1 of the first process cartridge 1 is transferred onto the transferring material in the first transferring position d1, the magenta toner image on the surface of the photosensitive drum 1 of the second process cartridge II is transferred onto the transferring material in the second transferring position d2, the cyan toner image on the surface of the photosensitive drum 1 of the third process cartridge III is transferred onto the transferring material in the third transferring position d3 and the black toner image on the surface of the photosensitive drum 1 of the fourth process cartridge IV is transferred onto the transferring material in the fourth transferring position d4 in a superimposed fashion. As a result, a target full-color toner image is formed on the surface of the transferring material.

The transferring material P conveyed by the transfer belt 51 and passed through the last fourth transferring nip portion d4 is separated from the transfer belt 51 and then is introduced into a thermal fixing device 8, where an unfixed full-color toner image is permanently fixed onto the surface of the transfer material with heat and pressure.

As mentioned above, in such an image forming apparatus of tandem type, if the separation of the electrifying carrier is generated in the upstream process cartridge(s) in the transferring material conveying direction, the downstream process cartridges will be contaminated via the transfer belt 51. That is to say, the separation of the electrifying carrier affects worst influence upon the most downstream process cartridge.

Here, regarding the most downstream fourth process cartridge IV, the same test as that in the second embodiment was performed. The test result is shown in the following Table 2.

The test result shown in the above Table 1 corresponding to the first process cartridge 1, and, although the test result regarding the fourth process cartridge IV shown in the Table 2 has less effect regarding the first process cartridge 1, when the main electrifying pole position angle θ is between 0° and −15°, the target sheet passing test of 50,000 sheets can be achieved.

The lower limit value of the angle θ is set to −15°. The reason is that, if the angle is smaller than this value, the main electrifying pole S1 is spaced apart from the photosensitive drum too great, with the result that it becomes difficult to collect the carrier by means of the main electrifying pole S1.

By the way, as can be seen from the Table 2, in order to collect the carrier substantially completely, the angle θ should be selected to θ<0°, and, in consideration of the above-mentioned lower limit value, the angle θ is preferably −15°≦θ<0° and more preferably −10°≦θ<0°.

TABLE 2

| Cartridge IV | +5° | 0° | −5° | −10° | Remarks |
|---|---|---|---|---|---|
| Carrier remaining | x | Δ | ∘ | ∘ | Δ: 1.4% |
| amount | | | | | reduction |
| White void | x | ∘ | ∘ | ∘ | |
| Drum scratch | x | Δ | ∘ | ∘ | Δ: OK up to |
| | | | | | 66,000 |
| Memory | x | ∘ | ∘ | ∘ | |
| Toner density | x | Δ | ∘ | ∘ | Δ: OK up to |
| | | | | | 81,000 |

∘: no problem
x: problem

<Others>

(1) The magnet brush electrifying means 22 may comprise a non-rotating member, in place of the rotating sleeve.

(2) Although the photosensitive drum as the image bering member (member to be charged) desirably has the low resistance surface layer having resistance of 10⁹ to 10¹⁴ Ω·cm in order to achieve the charge injecting electrification and to prevent generation of ozone, other organic photosensitive member may be used. That is to say, the contact electrification is not limited to the charge injecting electrification used in the embodiments, a contact electrifying system in which a discharging phenomenon is predominant may be used.

(3) While an example that the developing apparatus utilizes the two-component contact developing method was explained, other developing methods may be used. Preferably, one-component contact development or two-component contact development in which the latent image is developed while contacting the developer with the photosensitive member has higher effect for simultaneous collection of the developer.

The developing apparatus may be of reversal developing type or normal developing type.

(4) As an AC component wave form when the AC component (alternating voltage or alternate current voltage) is added to the bias applied to the electrifying device 2 and/or the developing apparatus 4, an appropriate wave form such as a sine wave form, a rectangular wave form or a triangular wave form may be used. Further, a rectangular wave form obtained by turning ON/OFF the DC power supply periodically may be used. In this way,

(5) The image forming process of the image forming apparatus is not limited to the embodiments, and the cleaner-less system may not be used. That is to say, an image forming apparatus having a cleaner may be used. In place of the transferring material, an intermediate transfer member such as an intermediate transfer drum or belt may receive the toner image from the image bearing member. Further, in place of the transferring system, an image forming apparatus of direct type may be used.

An image forming apparatus such as an image displaying apparatus (display device) in which a toner image is formed on an image bearing member and such an image is brought to a display portion for inspection or reading.

(6) The image exposing means for formation of the electrostatic latent image is not limited to the illustrated laser scan exposing means, but may be a normal analogue image exposure or other light emitting element devices such as an LED, or a combination of a light emitting element such as a fluorescent lamp and a liquid crystal shutter, so long as the electrostatic latent image corresponding to the image information can be formed.

(7) The image bearing member may be an electrostatic recording dielectric member. In this case, after a surface of the dielectric member is uniformly primary-electrified with predetermined polarity and potential, the dielectric member is subjected to selective electricity removal by means of electricity removing means such as an electricity removal probe head, and electronic gun and the like, thereby writing an electrostatic latent image corresponding to image information.

(8) The transferring means is not limited to the illustrated transfer belt device, but may be a corona charger (corona discharging transferring), a charging roller (roller transferring), a conductive brush, a conductive blade or the like.

(9) The magnet brush electrifying device of the present invention is not limited to be used for the electrifying process of the image bearing member of the image forming apparatus, but may be affectively used as electrification processing means for various members to be charged.

As mentioned above, while the present invention was explained in connection with embodiments thereof, the present invention is not limited to such embodiments, but, various alterations can be made within the scope of the invention.

What is claimed is:

1. An image forming apparatus comprising:
a shiftable image bearing member; and
electrifying means adapted to electrify said image bearing member and having magnetic particles contacted with said image bearing member and magnetic particle carrying means for magnetically holding and carrying the magnetic particles;
and wherein
a peak position of magnetic flux density of said magnetic particle carrying means near said image bearing member is located at a downstream side of a most approaching position between said magnetic particle carrying means and said image bearing member in a shifting direction of said image bearing member.

2. An image forming apparatus according to claim 1, wherein said image bearing member and said magnetic particle carrying means comprise rollers, and an angle θ formed between a line connecting a center of said magnetic particle carrying means to a center of said image bearing member and a line connecting the center of said magnetic particle carrying means to a peak position of the magnetic flux density is selected to 0°<θ≦15°.

3. An image forming apparatus according to claim 1, wherein said magnetic particle carrying means comprises a magnetic field generating member, and a rotary member surrounding said magnetic field generating member.

4. An image forming apparatus according to claim 3, wherein said magnetic field generating member has a magnetic pole disposed at a position corresponding to the peak position of the magnetic flux density.

5. An image forming apparatus according to claim 3, wherein said magnetic field generating member is a stationary fixed magnet roller.

6. A process cartridge detachable attachable to an image forming apparatus, comprising:
a shiftable image bearing member; and
electrifying means adapted to electrify said image bearing member and having magnetic particles contacted with said image bearing member and magnetic particle carrying means for magnetically holding and carrying the magnetic particles;
and wherein
a peak position of magnetic flux density of said magnetic particle carrying means near said image bearing member is located at a downstream side of a most approaching position between said magnetic particle carrying means and said image bearing member in a shifting direction of said image bearing member.

7. A process cartridge according to claim 6, wherein said image bearing member and said magnetic particle carrying means comprise rollers, and an angle θ formed between a line connecting a center of said magnetic particle carrying means to a center of said image bearing member and a line connecting the center of said magnetic particle carrying means to a peak position of the magnetic flux density is selected to 0°<θ≦15°.

8. A process cartridge according to claim 6, wherein said magnetic particle carrying means comprises a magnetic field generating member, and a rotary member surrounding said magnetic field generating member.

9. A process cartridge according to claim 8, wherein said magnetic field generating member has a magnetic pole disposed at a position corresponding to the peak position of the magnetic flux density.

10. A process cartridge according to claim 8, wherein said magnetic field generating member is a stationary fixed magnet roller.
